(19) United States
(12) Patent Application Publication
(10) Pub. No.: US 2025/0249957 A1
(43) Pub. Date: Aug. 7, 2025

(54) VEHICLE BODY STRUCTURE

(71) Applicant: TOYOTA JIDOSHA KABUSHIKI KAISHA, Toyota-shi (JP)

(72) Inventors: Shigenori HASHIDA, Nisshin-shi, Aichi-ken (JP); Soshiro MURATA, Toyota-shi, Aichi-ken (JP)

(21) Appl. No.: 18/970,900

(22) Filed: Dec. 6, 2024

(30) Foreign Application Priority Data
Feb. 2, 2024 (JP) 2024-015082

(51) Int. Cl. B62D 21/11; B62D 21/03; B62D 25/16

(52) U.S. Cl. CPC B62D 21/11; B62D 21/03; B62D 25/16

(57) ABSTRACT

A vehicle body structure includes: a cross member portion; and a left and right pair of wheel arches that are integrally formed with the cross member portion. The left and right pair of wheel arches are each include: a suspension tower portion including an upper wall portion that extends in a vehicle front-rear direction and the vehicle width direction, and to which a shock absorber is connected, and an apron upper member portion that extends in the vehicle front-rear direction, and that is formed along a peripheral end portion of the upper wall portion such that a portion of the apron upper member portion formed along the suspension tower portion is at a height that is lower than or equal to that of the upper wall portion and bypasses the shock absorber toward a vehicle width direction inner side in a plan view.

### CROSS-REFERENCE TO RELATED APPLICATION

This application is based on and claims priority under 35 USC 119 from Japanese Patent Application No. 2024-015082, filed on Feb. 2, 2024, the entire disclosure of which is incorporated by reference herein.

### BACKGROUND

### Technical Field

The present disclosure relates to a vehicle body structure.

### Related Art

International Publication (WO) No. 2022/031991 discloses an integral energy absorbing system including a front casting provided at a front end portion of a vehicle, and a rear casting provided at a rear end portion of the vehicle. In this technology, the front casting and the rear casting are each integrally molded by die casting, and are fixed to a center cab frame. By integrally molding each of the front casting and the rear casting as in this technology, a number of parts and a manufacturing cost can be reduced.

In the aforementioned technology, the front casting is configured to include a left and right pair of wheel wells (wheel arches), and a lateral direction support body (cross member portion) that connects the pair of wheel arches in a vehicle width direction. In the aforementioned technology, a portion corresponding to an apron upper member of the wheel arch (hereafter referred to as an “upper member portion”) extends in a vehicle front-rear direction at a vehicle upper side and at a vehicle width direction outer side of a portion corresponding to a suspension tower (hereafter referred to as a “suspension tower portion”).

In the aforementioned technology, a configuration is provided such that, when forming the left and right pair of wheel arches, respective molds are pulled out toward vehicle width direction outer sides.

However, in order to adopt a strut type suspension in which a spring is disposed above a tire, or to take a larger suspension stroke, it is desirable to secure a large up-down direction dimension of an accommodation space of the suspension tower portion. Namely, it is desirable for an upper wall portion formed at a vehicle upper side of the suspension tower portion to be higher than the upper member portion.

However, in a case in which the aforementioned structure is employed, when the upper member portion is disposed at the vehicle width direction outer side of the suspension tower portion as in the above-described prior art, the mold for molding the upper wall portion of the suspension tower portion interferes with the upper member portion when pulled out toward the vehicle width direction outer side, and therefore, the mold cannot be pulled out.

### SUMMARY

The present disclosure obtains a vehicle body structure that enables a pair of wheel arches and a cross member to be integrally molded while ensuring a large up-down direction dimension of an accommodation space of a suspension tower portion in a vehicle front portion.

A vehicle body structure according to a first aspect of the present disclosure includes: a cross member portion that extends in a vehicle width direction at a vehicle front portion; and a left and right pair of wheel arches that are respectively provided at both vehicle width direction sides of the cross member portion, and that are integrally formed with the cross member portion, wherein the left and right pair of wheel arches are each configured to include a suspension tower portion including an upper wall portion that extends in a vehicle front-rear direction and the vehicle width direction, and to which a shock absorber is connected, and an apron upper member portion that extends in the vehicle front-rear direction, and that is formed along a peripheral end portion of the upper wall portion such that a portion of the apron upper member formed along the suspension tower portion is at a height that is lower than or equal to that of the upper wall portion and bypasses the shock absorber toward a vehicle width direction inner side in a plan view.

According to the first aspect of the present disclosure, in the vehicle front portion, the cross member portion that extends in the vehicle width direction is integrally molded with the left and right pair of wheel arches that are respectively provided at both vehicle width direction sides of the cross member portion. The left and right pair of wheel arches are each configured to include the suspension tower portion and the apron upper member portion (hereafter referred to as an “upper member portion”).

In this regard, the suspension tower portion includes the upper wall portion that extends in the vehicle front-rear direction and the vehicle width direction, and to which the shock absorber is connected. In the upper member portion, the portion formed along the suspension tower portion is positioned at a height that is lower than or equal to that of the upper wall portion. Thus, the upper wall portion of the suspension tower portion is disposed at a high position.

The upper member portion is formed along the peripheral end portion of the upper wall portion such that the portion thereof formed along the suspension tower portion bypasses the shock absorber toward the vehicle width direction inner side in plan view. Consequently, even if the portion of the upper member portion formed along the suspension tower member is disposed at a height that is lower than or equal to that of the upper wall portion, when the wheel arch is molded, a mold can be pulled out toward the vehicle width direction outer side without a portion forming the upper wall portion of the mold interfering with the upper member portion.

A vehicle body structure according to a second aspect of the present disclosure is the vehicle body structure according to the first aspect, wherein the suspension tower portion includes a vertical wall portion that extends from the peripheral end portion of the upper wall portion toward a vehicle lower side, with at least a portion of the vertical wall portion being disposed at a vehicle width direction inner side of the shock absorber, and the apron upper member portion includes a lower side rib that extends out toward a vehicle width direction outer side from the vertical wall portion so as to face the upper wall portion.

According to the second aspect of the present disclosure, the vertical wall portion has a shape such that at least a portion of the vertical wall portion is disposed at the vehicle width direction inner side of the shock absorber, and can be molded, together with the upper wall portion, by a mold that is pulled out toward the vehicle width direction outer side. In this regard, a portion that is surrounded by the upper wall portion and the vertical wall portion of the suspension tower portion, and the lower side rib of the upper member portion, configures a concave portion that is substantially U-shaped in cross-section and that is open toward the vehicle width direction outer side. Thus, the concave portion including the lower side rib can be molded by a mold that is pulled out toward the vehicle width direction outer side.

A vehicle body structure according to a third aspect of the present disclosure is the vehicle body structure according to the first aspect, wherein the suspension tower portion includes a vertical wall portion that extends in a vehicle up-down direction, with at least a portion of the vertical wall portion being disposed at a vehicle width direction inner side of the shock absorber, and the apron upper member portion includes an outer wall portion that extends from the peripheral end portion of the upper wall portion toward a vehicle lower side, an inner wall portion that is formed facing the outer wall portion at an upper end portion of the vertical wall portion, and a bottom portion that connects a lower end portion of the outer wall portion and a lower end portion of the inner wall portion.

According to the third aspect of the present disclosure, a concave portion that is surrounded by the outer wall portion and the bottom portion of the apron upper member portion, and the inner wall portion formed at an upper end portion of the upper member portion, is formed. Thus, since the wheel arch includes the outer wall portion and the bottom portion of the apron upper member portion in addition to the upper wall portion and the vertical wall portion of the suspension tower portion, and since the outer wall portion and the bottom portion are orthogonal to each other, rigidity of the apron upper member portion is improved compared to a case in which the apron upper member portion is configured with only a rib extending in one direction.

A vehicle body structure according to a fourth aspect of the present disclosure is the vehicle body structure according to the third aspect, wherein the apron upper member portion includes plural reinforcing ribs that each extend in the vehicle up-down direction, that connect the outer wall portion, the inner wall portion, and the bottom portion, and that are provided at intervals from each other.

According to the fourth aspect of the present disclosure, the concave portion surrounded by the inner wall portion, the bottom portion, and the outer wall portion is reinforced, so as not to collapse, by the plural reinforcing ribs provided at intervals from each other. Thus, the rigidity of the apron upper member portion is improved. Furthermore, the concave portion is formed substantially in a U-shape in cross-section that is open toward the vehicle upper side. Thus, the plural reinforcing ribs can also be molded by a mold that is pulled out toward the vehicle upper side when molding a recessed face of the concave portion.

A vehicle body structure according to a fifth aspect of the present disclosure is the vehicle body structure according to the first aspect, wherein a left and right pair of front side member portions that extend in the vehicle front-rear direction are respectively disposed at a vehicle lower side and a vehicle width direction inner side of each suspension tower portion in the left and right pair of wheel arches, and the front side member portions are integrally molded with the left and right pair of wheel arches.

According to the fifth aspect of the present disclosure, not only the cross member portion and the left and right pair of wheel arches, but also the left and right pair of front side member portions are integrally molded. Consequently, the number of parts and the manufacturing processes can be reduced.

As explained above, the vehicle body structure according to the first aspect of the present disclosure has an effect in that a pair of wheel arches and a cross member can be integrally molded while ensuring a large up-down direction dimension of an accommodation space of a suspension tower portion in a vehicle front portion.

The vehicle body structure according to the second aspect of the present disclosure has an effect in that an apron upper member of a vehicle can be configured, and rigidity thereof can be improved, with a simple configuration.

The vehicle body structure according to the third aspect of the present disclosure has an effect in that rigidity of an apron upper member portion can be improved.

The vehicle body structure according to the fourth aspect of the present disclosure has an effect in that molding can be easily carried out while improving rigidity of an apron upper member portion.

The vehicle body structure according to the fifth aspect of the present disclosure has an effect in that the number of parts and the manufacturing processes can be reduced.

### BRIEF DESCRIPTION OF THE DRAWINGS

An exemplary embodiment of the present disclosure will be described in detail based on the following figures, wherein:

FIG. 1 is a front perspective view in which a vehicle body to which a vehicle body structure according to the present exemplary embodiment has been applied is viewed from a vehicle front left side;

FIG. 2 is a rear perspective view illustrating an enlarged view of a vicinity of a right side suspension tower portion illustrated in FIG. 1;

FIG. 3 is a cross-sectional view taken along line 3-3 in FIG. 2;

FIG. 4 is a cross-sectional view taken along line 4-4 in FIG. 2;

FIG. 5 is an enlarged front perspective view of a main portion of a front casting of a vehicle body to which a vehicle body structure according to a modified example has been applied; and

FIG. 6 is a cross-sectional view taken along line 6-6 in FIG. 5.

### DETAILED DESCRIPTION

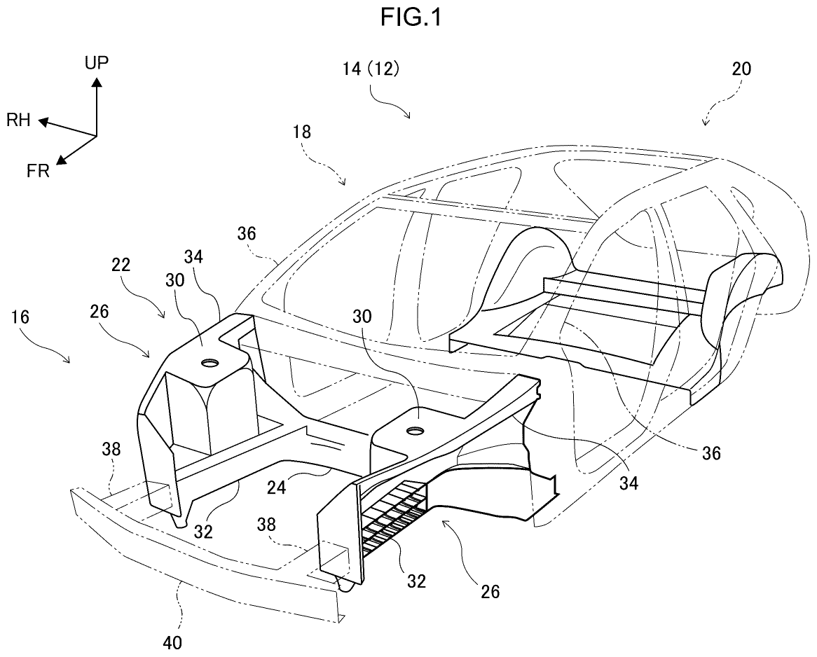

A vehicle body of a vehicle to which a vehicle body structure according to an exemplary embodiment of the present disclosure has been applied will be explained below, with reference to FIGS. 1 to 4. It should be noted that, in the respective drawings as appropriate, arrow FR, arrow UP, and arrow RH respectively indicate a front side, an upper side, and a left and right direction (width direction) right side of the vehicle. Further, unless specifically stated otherwise, in the following explanation, in cases in which front and rear, up and down, and left and right directions are used, these respectively indicate front and rear in a vehicle front-rear direction, up and down in a vehicle up-down direction, and left and right in a vehicle left-right direction (width direction).

FIG. 1 illustrates a vehicle body 14 of a vehicle 12 to which a vehicle body structure according to the present exemplary embodiment has been applied. The vehicle body 14 is configured to include a front body 16 configuring a vehicle front side portion, a center body 18 configuring a vehicle front-rear direction central portion, and a rear body 20 configuring a vehicle rear side portion.

The front body 16 is provided with a front casting 22 that is integrally molded, for example, by aluminum die casting. The front casting 22 includes a cross member portion 24 extending in the vehicle width direction at a vehicle front side of the center body 18, and a left and right pair of wheel arches 26 provided at both vehicle width direction sides of the cross member portion 24. It should be noted that, since the front casting 22 is configured with left-right symmetry, in the following explanation, a configuration at the right side will be mainly explained, and explanation regarding a configuration at the left side will be omitted.

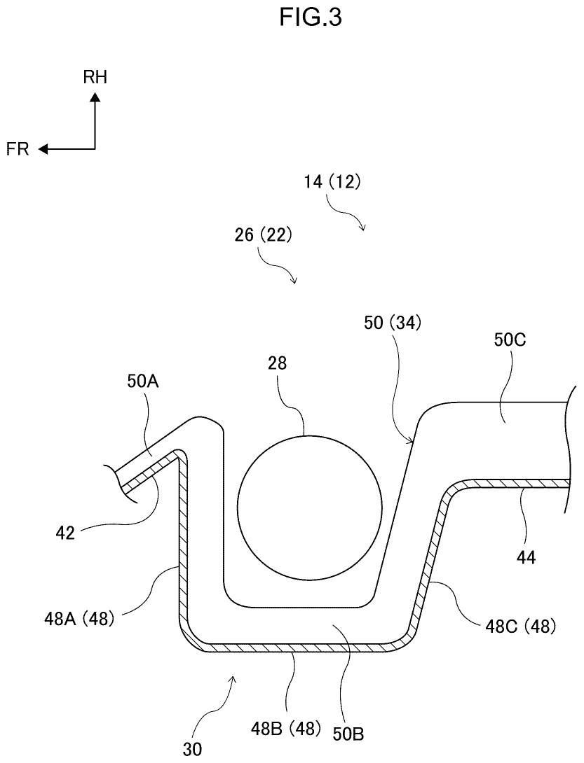

Each wheel arch 26 is configured such that a wheel (not illustrated in the drawings) and a shock absorber 28 (refer to FIG. 3) to which a spring (not illustrated in the drawings) is attached can be accommodated at a vehicle width direction outer side thereof.

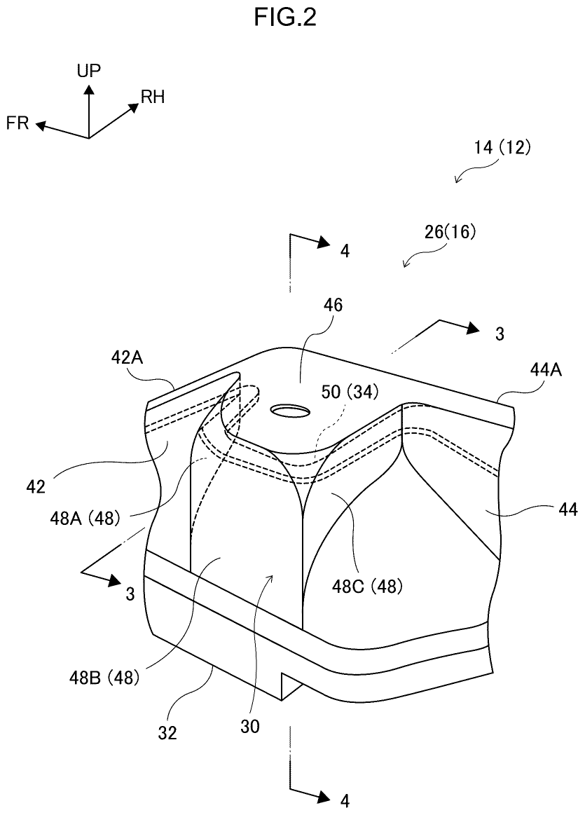

The wheel arch 26 includes a suspension tower portion 30 to which the shock absorber 28 (refer to FIG. 3) is connected. The suspension tower portion 30 is formed in a box shape that is open at a vehicle width direction outer side thereof and at a vehicle lower side thereof. Details of the suspension tower portion 30 will be described later with reference to FIG. 2.

The wheel arch 26 includes a front side member portion 32 that extends

substantially in the vehicle front-rear direction at a vehicle lower side and a vehicle width direction inner side of the suspension tower portion 30. The front side member portion 32 configures a frame at a lower portion of the front body 16.

Further, the wheel arch 26 includes an apron upper member portion 34 (hereafter referred to as an “upper member portion 34”) that extends substantially in the vehicle front-rear direction at a vehicle upper side and a vehicle width direction outer side of the front side member portion 32. A rear end portion of the upper member portion 34 is joined to a front pillar 36. The upper member portion 34 configures a frame at an upper portion side of the front body 16.

A crash box 38 that is capable of absorbing collision energy during a frontal collision of the vehicle 12 extends in the vehicle front-rear direction at a vehicle front side of each front side member portion 32. Front end portions of the left and right crash boxes 38 are connected in the vehicle width direction by a front bumper 40.

FIG. 2 is a rear perspective view illustrating an enlarged view of a vicinity of the right side suspension tower portion 30. The wheel arch 26 includes a wheel arch front portion 42 formed at a vehicle front side of the suspension tower portion 30, and a wheel arch rear portion 44 formed at a vehicle rear side of the suspension tower portion 30. A front flange portion 42A extending out toward the vehicle width direction outer side is formed at an upper end portion of the wheel arch front portion 42. Similarly, a rear flange portion 44A extending out toward the vehicle width direction outer side is formed at an upper end portion of the wheel arch rear portion 44.

Further, the suspension tower portion 30 is configured to include an upper wall portion 46 that extends substantially horizontally and to which the shock absorber 28 (refer to FIG. 3) is connected at a vehicle lower side thereof, and a vertical wall portion 48 that is extended toward the vehicle lower side from a peripheral end portion of the upper wall portion 46. The upper wall portion 46 is flush with the front flange portion 42A and the rear flange portion 44A.

As illustrated in FIG. 3, the vertical wall portion 48 is formed substantially in a U-shape that is open toward the vehicle width direction outer side in planar cross-sectional view. The vertical wall portion 48 is configured to include a front wall portion 48A extending substantially in the vehicle width direction at a vehicle front side, a side wall portion 48B extending substantially toward the vehicle rear side from a vehicle width direction inner side end portion of the front wall portion 48A, and a rear wall portion 48C extending substantially toward the vehicle width direction outer side from a rear end portion of the side wall portion 48B. The shock absorber 28 is disposed between the front wall portion 48A and the rear wall portion 48C, and at a vehicle width direction outer side of the side wall portion 48B. The front wall portion 48A and the rear wall portion 48C are provided so as to face each other while becoming further apart from each other on progression toward the vehicle width direction outer side. Consequently, the suspension tower portion 30 can be formed by a mold that is pulled out toward the vehicle width direction outer side.

As illustrated in FIG. 2, the upper member portion 34 includes a lower side rib 50 formed along the wheel arch front portion 42, the vertical wall portion 48, and the wheel arch rear portion 44. The lower side rib 50 extends out toward the vehicle width direction outer side from the wheel arch front portion 42, the vertical wall portion 48, and the wheel arch rear portion 44, respectively.

The lower side rib 50 is configured to include a front portion 50A formed along the wheel arch front portion 42, a middle portion 50B formed along the vertical wall portion 48 of the suspension tower portion 30, and a rear portion 50C formed along the wheel arch rear portion 44.

The front portion 50A is formed facing the front flange portion 42A at a vehicle lower side of the front flange portion 42A. Similarly, the rear portion 50C is formed facing the rear flange portion 44A at a vehicle lower side of the rear flange portion 44A.

Further, the middle portion 50B is formed facing the upper wall portion 46 at a vehicle lower side of the upper wall portion 46. The middle portion 50B is formed substantially in a U-shape that is open toward the vehicle width direction outer side in a plan view, along each of the front wall portion 48A, the side wall portion 48B, and the rear wall portion 48C. The middle portion 50B is formed continuously with the front portion 50A and the rear portion 50C. Namely, as illustrated in FIG. 3, the lower side rib 50 is formed along an upper portion of the wheel arch front portion 42, an upper portion of the vertical wall portion 48 of the suspension tower portion 30, and an upper portion of the wheel arch rear portion 44 so as to bypass the shock absorber 28 toward the vehicle width direction inner side in a plan view.

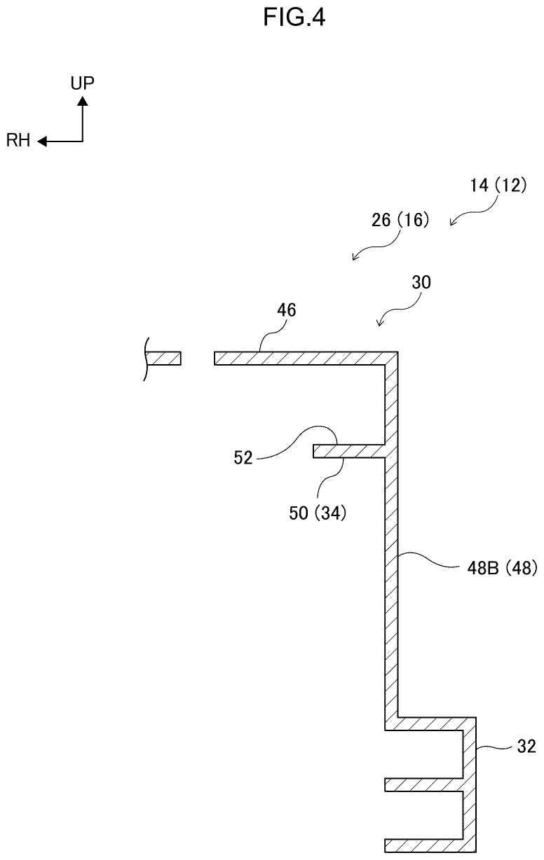

As illustrated in FIG. 4, the front side member portion 32 is formed substantially in an E-shape that is open toward the vehicle width direction outer side in a vertical cross-sectional view viewed from the vehicle front side. Further, an upper portion of the suspension tower portion 30 is formed substantially in a U-shape that is open toward the vehicle width direction outer side due to the lower side rib 50 extending out from the vertical wall portion 48. A portion surrounded by the upper wall portion 46, the side wall portion 48B, and the lower side rib 50 configures a concave portion 52 that is substantially U-shaped in cross-section and that is open toward the vehicle width direction outer side.

### Operation

Next, operation of the present exemplary embodiment will be explained.

According to the vehicle body structure according to the present exemplary embodiment, as illustrated in FIG. 1, in the front casting 22 of the front body 16 of the vehicle 12, the cross member portion 24 extending in the vehicle width direction is integrally molded with the left and right pair of wheel arches 26.

As illustrated in FIG. 2, the suspension tower portion 30 includes the upper wall portion 46 that extends in the vehicle front-rear direction and the vehicle width direction, and to which the shock absorber 28 (refer to FIG. 3) is connected. In the upper member portion 34, the middle portion 50B formed along the suspension tower portion 30 is positioned at a height that is lower than or equal to that of the upper wall portion 46. Thus, the upper wall portion 46 of the suspension tower portion 30 is disposed at a high position.

As illustrated in FIG. 3, the upper member portion 34 is formed along the peripheral end portion of the upper wall portion 46 such that a portion of the upper member portion 34 formed along the suspension tower portion 30 bypasses the shock absorber 28 toward the vehicle width direction inner side in a plan view. Consequently, as illustrated in FIG. 2 and FIG. 4, even if the middle portion 50B of the upper member portion 34 is disposed at a height that is lower than that of the upper wall portion 46, when the wheel arch 26 is molded, a mold (not illustrated in the drawings) can be pulled out toward the vehicle width direction outer side without a portion forming the upper wall portion 46 of the mold interfering with the upper member portion 34.

Further, according to the vehicle body structure according to the present exemplary embodiment, as illustrated in FIG. 3, the vertical wall portion 48 has a shape in which the side wall portion 48B is disposed at a vehicle width direction inner side of the shock absorber 28, and can be molded by a mold that is pulled out toward the vehicle width direction outer side, together with the upper wall portion 46 illustrated in FIG. 4. In this regard, the portion that is surrounded by the upper wall portion 46, the side wall portion 48B, and the lower side rib 50 configures the concave portion 52 that is substantially U-shaped in cross-section and that is open toward the vehicle width direction outer side. Thus, the concave portion 52 including the lower side rib 50 can be formed by a mold that is pulled out toward the vehicle width direction outer side.

Moreover, according to the vehicle body structure according to the present exemplary embodiment, as illustrated in FIG. 1, not only the cross member portion 24 and the left and right pair of wheel arches 26, but also the left and right pair of front side member portions 32 are integrally molded. Consequently, the number of parts and the manufacturing processes can be reduced.

### Supplementary Explanation of the Above-Described Exemplary Embodiment

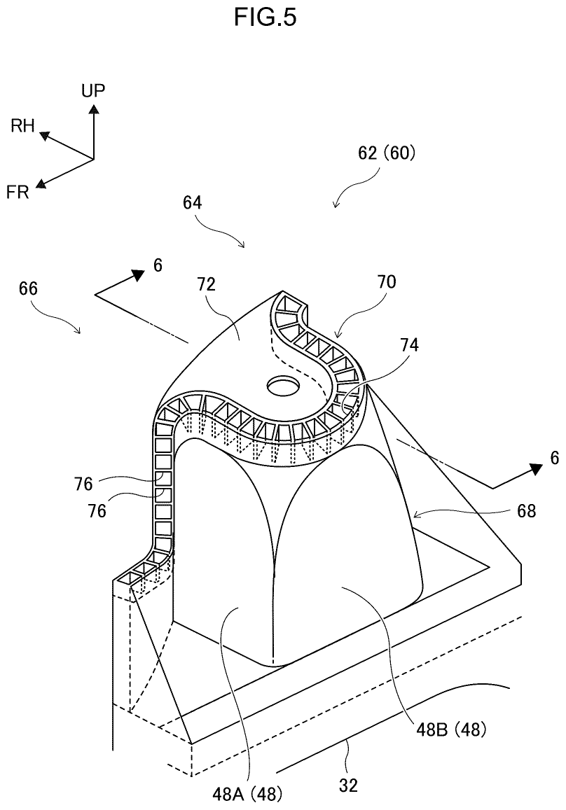

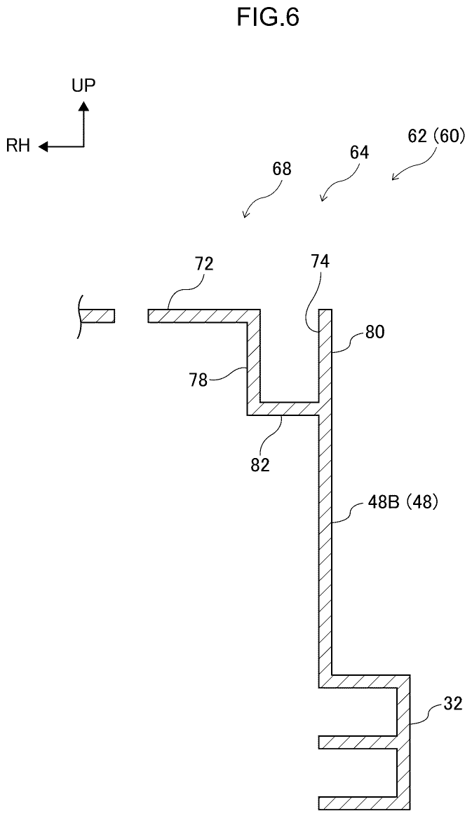

In the above-described exemplary embodiment, the lower side rib 50 configuring the upper member portion 34 has been explained as being provided facing the upper wall portion 46 further toward the lower side than the upper wall portion 46; however, there is no limitation thereto, and the upper member portion may be formed at a height that is lower than or equal to that of the upper wall portion. For example, a vehicle body structure according to a modified example illustrated in FIG. 5 and FIG. 6 may be employed. It should be noted that, in the following modified example, configurations that are the same as those in the above-described exemplary embodiment are appended with the same reference numerals, and explanation thereof is appropriately omitted.

### Modified Example

FIG. 5 is an enlarged front perspective view of a main portion of a front casting 64 of a vehicle body 62 of a vehicle 60 including a vehicle front portion structure according to a modified example. The front casting 64 includes the cross member portion 24 (refer to FIG. 1) extending in the vehicle width direction at a vehicle front portion, and wheel arches 66 respectively provided at both vehicle width direction sides of the cross member portion 24. The pair of wheel arches 66 are integrally molded with the cross member portion 24 (refer to FIG. 1).

As illustrated in FIG. 5, each wheel arch 66 includes a suspension tower portion 68, an apron upper member portion 70 (hereafter referred to as an “upper member portion 70”), and the front side member portion 32.

The suspension tower portion 68 is configured to include an upper wall portion 72 that extends in a substantially horizontal direction and to which the shock absorber 28 (refer to FIG. 3) is connected, and the vertical wall portion 48 that extends in the vehicle up-down direction. The upper wall portion 72 and the vertical wall portion 48 are connected by the upper member portion 70.

The upper member portion 70 is provided at a height that is lower than or equal to that of the upper wall portion 72, and includes a concave portion 74 that is recessed at a vehicle lower side, and a plurality of reinforcing ribs 76 that are provided at intervals from each other in the concave portion 74.

As illustrated in FIG. 5 and FIG. 6, the concave portion 74 is configured to include an outer wall portion 78 that is extended toward the vehicle lower side from a peripheral end portion of the upper wall portion 72, an inner wall portion 80 that is formed facing the outer wall portion 78 at an upper end portion of the vertical wall portion 48, and a bottom portion 82 that connects a lower end portion of the outer wall portion 78 and a lower end portion of the inner wall portion 80.

The plurality of reinforcing ribs 76 each extend in the vehicle up-down direction at the concave portion 74, and connect the outer wall portion 78, the inner wall portion 80, and the bottom portion 82. An upper face of each reinforcing rib 76 is, for example, flush with the upper wall portion 72.

According to the present modified example, the concave portion 74 surrounded by the outer wall portion 78, the bottom portion 82, and the inner wall portion 80 is formed. Thus, since the wheel arch 66 includes the outer wall portion 78 and the bottom portion 82 of the upper member portion 70 in addition to the upper wall portion 72 and the vertical wall portion 48 of the suspension tower portion 68, and since the outer wall portion 78 and the bottom portion 82 are orthogonal to each other, rigidity of the upper member portion 70 is improved compared to a configuration in which the upper member portion is configured with only a rib extending in one direction.

Further, the concave portion 74 surrounded by the inner wall portion 80, the bottom portion 82, and the outer wall portion 78 is reinforced, so as not to collapse, by the plural reinforcing ribs 76 provided at intervals from each other. Thus, the rigidity of the upper member portion 70 is improved. Furthermore, the concave portion 74 is formed substantially in a U-shape in cross-section that is open toward the vehicle upper side. Thus, the plural reinforcing ribs 76 can also be molded by a mold that is pulled out toward the vehicle upper side when molding a recessed face of the concave portion 74.

It should be note that, in the above-described exemplary embodiment, a reinforcing rib may be provided at a vehicle upper side of the lower side rib 50. In such a case, the reinforcing rib is provided along the vehicle width direction in order to pull out the mold toward the vehicle width direction outer side. In that case, plural reinforcing ribs may be provided, as in the modified example. Furthermore, it is not necessary for the reinforcing ribs 76 to be formed at the concave portion 74 of the modified example.

Further, although the front casting 22 of the above-described exemplary embodiment and the front casting 64 of the modified example have been explained as being integrally molded by aluminum die casting, there is no limitation thereto. For example, the cross member portion and the left and right pair of wheel arches may be integrally molded from resin. In such a case, as in the above-described exemplary embodiment and modified example, the left and right pair of front side members may also be integrally molded from resin.

Moreover, in the above-described exemplary embodiment and modified example, although the left and right pair of front side member portions 32 have also been explained as being integrally molded, there is no limitation thereto, and the left and right pair of front side members may be molded as separate bodies from the left and right pair of wheel arches and the cross member portion.

With regard to the above-described exemplary embodiment, the following additional notes are further disclosed.

### Additional Note 1

A vehicle body structure comprising:
a cross member portion that extends in a vehicle width direction at a vehicle front portion; and
a left and right pair of wheel arches that are respectively provided at both vehicle width direction sides of the cross member portion, and that are integrally formed with the cross member portion,
wherein the left and right pair of wheel arches are each configured to include:
   a suspension tower portion including an upper wall portion that extends in a vehicle front-rear direction and the vehicle width direction, and to which a shock absorber is connected, and
   an apron upper member portion that extends in the vehicle front-rear direction, and that is formed along a peripheral end portion of the upper wall portion such that a portion of the apron upper member portion formed along the suspension tower portion is at a height that is lower than or equal to that of the upper wall portion and bypasses the shock absorber toward a vehicle width direction inner side in a plan view.

### Additional Note 2

The vehicle body structure according to Additional Note 1, wherein:
the suspension tower portion includes a vertical wall portion that extends from the peripheral end portion of the upper wall portion toward a vehicle lower side, at least a portion of the vertical wall portion being disposed at a vehicle width direction inner side of the shock absorber; and
the apron upper member portion includes a lower side rib that extends out toward a vehicle width direction outer side from the vertical wall portion so as to face the upper wall portion.

### Additional Note 3

The vehicle body structure according to Additional Note 1, wherein:
the suspension tower portion includes a vertical wall portion that extends in a vehicle up-down direction, at least a portion of the vertical wall portion being disposed at a vehicle width direction inner side of the shock absorber; and
the apron upper member portion includes an outer wall portion that extends from the peripheral end portion of the upper wall portion toward a vehicle lower side, an inner wall portion that is formed facing the outer wall portion at an upper end portion of the vertical wall portion, and a bottom portion that connects a lower end portion of the outer wall portion and a lower end portion of the inner wall portion.

### Additional Note 4

The vehicle body structure according to Additional Note 3, wherein the apron upper member portion includes a plurality of reinforcing ribs that each extend in the vehicle up-down direction, that connect the outer wall portion, the inner wall portion, and the bottom portion, and that are provided at intervals from each other.

### Additional Note 5

The vehicle body structure according to any one of Additional Note 1 to Additional Note 4, wherein a left and right pair of front side member portions that extend in the vehicle front-rear direction are respectively disposed at a vehicle lower side and a vehicle width direction inner side of each suspension tower portion in the left and right pair of wheel arches, and the front side member portions are integrally molded with the left and right pair of wheel arches.

What is claimed is:

1. A vehicle body structure comprising:
a cross member portion that extends in a vehicle width direction at a vehicle front portion; and
a left and right pair of wheel arches that are respectively provided at both vehicle width direction sides of the cross member portion, and that are integrally formed with the cross member portion,
wherein the left and right pair of wheel arches are each configured to include:
a suspension tower portion including an upper wall portion that extends in a vehicle front-rear direction and the vehicle width direction, and to which a shock absorber is connected, and
an apron upper member portion that extends in the vehicle front-rear direction, and that is formed along a peripheral end portion of the upper wall portion such that a portion of the apron upper member portion formed along the suspension tower portion is at a height that is lower than or equal to that of the upper wall portion and bypasses the shock absorber toward a vehicle width direction inner side in a plan view.

2. The vehicle body structure according to claim 1, wherein:
the suspension tower portion includes a vertical wall portion that extends from the peripheral end portion of the upper wall portion toward a vehicle lower side, at least a portion of the vertical wall portion being disposed at a vehicle width direction inner side of the shock absorber; and
the apron upper member portion includes a lower side rib that extends out toward a vehicle width direction outer side from the vertical wall portion so as to face the upper wall portion.

3. The vehicle body structure according to claim 1, wherein:
the suspension tower portion includes a vertical wall portion that extends in a vehicle up-down direction, at least a portion of the vertical wall portion being disposed at a vehicle width direction inner side of the shock absorber; and
the apron upper member portion includes an outer wall portion that extends from the peripheral end portion of the upper wall portion toward a vehicle lower side, an inner wall portion that is formed facing the outer wall portion at an upper end portion of the vertical wall portion, and a bottom portion that connects a lower end portion of the outer wall portion and a lower end portion of the inner wall portion.

4. The vehicle body structure according to claim 3, wherein the apron upper member portion includes a plurality of reinforcing ribs that each extend in the vehicle up-down direction, that connect the outer wall portion, the inner wall portion, and the bottom portion, and that are provided at intervals from each other.

5. The vehicle body structure according to claim 1, wherein a left and right pair of front side member portions that extend in the vehicle front-rear direction are respectively disposed at a vehicle lower side and a vehicle width direction inner side of each suspension tower portion in the left and right pair of wheel arches, and the front side member portions are integrally molded with the left and right pair of wheel arches.
